(19) United States
(12) Patent Application Publication
(10) Pub. No.: US 2012/0097193 A1
(43) Pub. Date: Apr. 26, 2012

(54) DETERGENT COMPOSITION

(75) Inventors: Emanuele Rossetto, Ludwigshafen (DE); Diatmar van Loyen, Ludwigshafen (DE)

(73) Assignee: Reckitt Benckiser N.V., WT Hoofddorp (NL)

(21) Appl. No.: 13/263,418

(22) PCT Filed: Apr. 6, 2010
(86) PCT No.: PCT/GB2010/000706

§ 371 Date: Dec. 19, 2011

(30) Foreign Application Priority Data
Apr. 9, 2009 (GB) 0906281.1

(51) Int. Cl. B08B 3/08; B65D 85/00

(52) U.S. Cl. 134/25.2; 206/524.7; 206/216

(57) ABSTRACT

A unit dose detergent composition comprising 1) a water soluble or water dispersible package comprising water soluble or water dispersible packaging material and a bleaching composition comprising a bleaching compound, the bleaching composition being at least partly enveloped by the packaging material and 2) at least one additional solid detergent composition comprising a bleach sensitive material and a surfactant and/or builder.

### TECHNICAL FIELD

The present invention relates to unit dose detergent compositions comprising at least 2 different compositions. In particular the present invention relates to such compositions to be used in automatic washing processes, such as automatic dishwashing and especially in multi-dosing devices used in these processes.

### BACKGROUND AND PRIOR ART

It is well known to use unit dose detergent compositions in applications such as laundry and automatic dishwashing. These compositions are provided in a portion size sufficient for a single washing operation.

In order to obtain good cleaning performance on bleachable stains, e.g. tea, it is desirable to include a bleaching component in detergent compositions. However, it is well known in the art that the presence of a bleach in a detergent composition can lead to instability of the composition especially when bleach-sensitive ingredients such as enzymes and perfumes are present. Furthermore the bleach itself is susceptible to stability problems e.g. when in contact with moisture and/or above ambient temperatures. This can be a particular problem in detergent compositions which are stored for significant periods of time in conditions of high humidity and/or above ambient temperature e.g. in a multi-dosing detergent dispensing device in which the detergent composition is stored inside an automatic washing machine (such as an automatic dishwashing machine) over a plurality of washing cycles. The exposure to the warm, humid conditions can cause the bleach to become unstable and decompose to at least some extent. This can also result in the decomposition of other ingredients of the detergent composition and thus instability of the composition arises.

It has been attempted to address the above problems in unit dose compositions which are not intended to be used in a multi-dosing dispensing device (and which are not subjected to cyclic hot/humid conditions) by separating the bleaching compound and the bleach sensitive ingredient into different regions in order to reduce the possibility that the bleach will adversely affect the stability of the other ingredients and compositions of this type are already commercially available.

Simply separating these ingredients into different regions has not been found to sufficiently address the instability problem of the bleach sensitive ingredient especially under the cyclical warm and/or humid conditions found in a multi dosing detergent device as some reaction still generally takes place between the bleaching compound and the bleach sensitive ingredient at the interface of the two regions and thus stability of the detergent compositions and/or performance may still desirably be improved.

DE-A-4009532 discloses a cleaning composition formed from two detergent pastes. One paste comprises the enzyme, zeolite A builder and other bleach sensitive ingredients and the other paste comprises perborate monohydrate builder.

EP-A-976820 discloses three layered tablets wherein the external layers comprise the enzyme system and the central layer comprises a bleaching system. The layer comprising the enzyme system may also comprise a builder.

WO 2004/081161 discloses bleach (PAP) encapsulated with a water soluble coating such as gelatin. This bleach containing capsule is disclosed in combination with a liquid composition inside a water soluble outer container.

EP-A-1,735,422 and EP-A-1,735,423 disclose bleach with a water soluble coating such as poly vinyl alcohol.

EP-A-1,364,610 discloses a detergent system comprising a plurality of preformed sub-units packaged together in a water soluble film wrap such that certain ingredients are separated into different sub-units.

GB-A-2,440,796 discloses a tablet comprising a main body of a compressed particulate material and a minor body having a non-rigid wall fixed to the main body.

WO 2003/038027 discloses a detergent system comprising at least one solid detergent in the form of a tablet and at least one liquid or gel filled pouch packaged together in a water-insoluble film wrap.

Despite the above there is still a need to improve stability of detergent compositions comprising bleach sensitive ingredients and a bleaching compound, especially for unit dose detergent compositions to be used in a multi-dosing detergent device.

It is an object of the present invention to address one or more of the above-mentioned problems. In particular, it is an object of the present invention to provide bleach-containing detergent compositions which exhibit good stability, especially of the bleach and the bleach sensitive ingredients. It is a further object of the present invention to provide bleach containing detergent compositions exhibiting good stability and/or performance when used in a multi-dosing detergent device e.g. in an automatic dishwashing machine.

### Statement of Invention

It has surprisingly been found that one or more of the above problems can be addressed by the compositions of the present invention.

Thus according to the present invention there is provided a unit dose detergent composition comprising 1) a water soluble or water dispersible package comprising water soluble or water dispersible packaging material and a bleaching composition comprising a bleaching compound, the bleaching composition being at least partly enveloped by the packaging material and 2) at least one additional solid detergent composition comprising a bleach sensitive material and a surfactant and/or builder and which is not enveloped by the packaging material.

Preferably the composition is dishwashing composition and in particular an automatic dishwashing detergent composition.

It is preferred that the water soluble or water dispersible packaging material comprises a water soluble or water dispersible polymeric material selected from polyvinyl alcohol, celluloses, starches, gelatine, polyglycolides, gelatine and polylactides copolymers or a mixture or co-polymer thereof. According to the present invention the term ‘cellulose’ as used herein includes cellulose ethers.

The bleaching composition comprises 25% wt to 99% wt of the bleaching compound based on the total weight of the bleaching composition, preferably 50% wt to 95% wt, such as 70% wt to 90% wt.

Preferably the bleaching composition is in a solid, slurry or gel form. The solid form is preferably in particulate or tablet form.

The bleaching compound preferably comprises at least one inorganic peroxide or organic peracid or a chlorine based bleach including derivatives and salts thereof or mixtures thereof. It is preferred that the at least one inorganic peroxide comprises a percarbonate, perborate, persulphate and/or hydrogen peroxide including derivatives and salts thereof and mixtures thereof.

It is preferred that the at least one organic peracid comprises perbenzoic acid and/or a peroxycarboxylic acid.

Preferably the at least one peroxycarboxylic acid comprises monoperoxyphthalic acid, diperoxyphthalic acid, 2-octyldiperoxysuccinic acid, diperoxydodecanedicarboxylic acid, diperoxy-azelaic acid, imidoperoxycarboxylic acid or phthalimidoperhexanoic acid including derivatives and salts thereof and mixtures thereof.

According to a preferred embodiment of the present invention the unit dose detergent product comprises at least two of the additional detergent compositions in solid form.

It is preferred that the surfactant comprises non-ionic surfactant, especially for automatic dishwashing compositions.

If a builder is present in the solid detergent compositions it may be either phosphorous-containing or phosphorous-free. If a phosphorous-free builder is present it preferably comprises amino acid based compounds and/or succinate based compounds, most especially methyl-glycine-diacetic acid, glutamic-N,N-diacetic acid, tetrasodium imminosuccinate, or (hydroxy)iminodisuccinic acid and salts or derivatives thereof.

The at least one additional solid detergent composition further comprises a dissolution retarder. This has been found to be especially beneficial when the unit dose detergent composition is used in a multi-dosing detergent device where in use cyclic warm, humid cycles are typically experienced.

Preferably the additional solid detergent composition is in the form of a shaped body. Preferably in use the water soluble or water dispersible package is positioned substantially between at least two of the additional detergent compositions to protect the package from external influences such as moisture.

According to a second aspect of the present invention there is provided a kit-of-parts comprising 1) a water-insoluble receptacle comprising at least one chamber for retaining at least one detergent composition and 2) a unit dose detergent composition according to the first aspect of the invention.

It is especially preferred that the water-insoluble receptacle comprises a plurality of chambers. It is most preferred that at least one chamber of the water-insoluble receptacle contains a unit dose detergent composition of the first aspect of the invention and especially that each chamber contains such a unit dose detergent composition.

According to a most preferred aspect of the present invention from 2 to 30 of the unit dose detergent compositions are individually retained by the same number of chambers in the water-insoluble receptacle; this is especially advantageous when the receptacle plus unit dose detergent compositions are used in a multi-dosing detergent device.

In use, the water soluble or water dispersible package is preferably located substantially between at least two additional detergent compositions. This has the advantage of providing at least some protection for the package against detrimental external influences.

According to a third aspect of the present invention there is provided the use of the unit dose detergent composition according to the first aspect of the invention or the kit-of-parts according to the second aspect of the invention in a washing operation, especially in an automatic dishwashing operation.

It is especially preferred that the unit dose detergent composition and the kit of parts according to the invention are used in a multi-dosing detergent device.

According to a forth aspect of the present invention there is provided a multi-dosing detergent device comprising the unit dose detergent composition according to the first aspect of the present invention or the kit-of-parts according to the second aspect of the present invention.

Surprisingly, it has been found that compositions according to the present invention exhibit good stability and/or performance especially in conditions that are normally detrimental to stability e.g. temperatures above ambient and/or humid conditions, especially those as would be encountered in use in a multi-dose detergent device such as in an automatic dishwashing machine.

Unless stated otherwise, all amounts herein are given as the percentage by weight of active ingredient based upon the weight of the total composition.

The term ‘region’ as used herein means a region either having a different composition to the adjacent region(s) or which is formed in a separate operation to the adjacent region(s).

The term x substantially free of as used herein means less than 0.5% wt of the material in question based on the total weight of that material in the detergent composition.

The term ‘at least partially enveloped’ as used herein means that the water soluble or water dispersible packaging material at least partly surrounds the bleaching composition.

### DETAILED DESCRIPTION

The present invention will now be described in further detail.

### Unit Dose Detergent Compositions

The unit dose detergent compositions of the invention may be used in principle for any cleaning operation. However, it is preferred that the detergent compositions are laundry detergents or hard surface cleaning compositions for example dishwashing detergents, floor cleaners or surface cleaners. It is most preferred that the hard surface cleaning compositions are dishwashing compositions and in particular automatic dishwashing compositions.

A unit dose detergent composition is designed to be used as a single portion of detergent composition in a single washing operation. Of course, one or more of such single portions may be used in a cleaning operation if desired.

The unit dose detergent composition of the present invention comprises 1) a water soluble or water dispersible package comprising water soluble or water dispersible packaging material and a bleaching composition comprising a bleaching compound, the composition being at least partly enveloped by the packaging material and 2) at least one additional solid detergent composition comprising a bleach sensitive material and a surfactant and/or builder and which is not enveloped by the packaging material.

It is possible that the at least one additional solid detergent composition has a water dispersible or water soluble covering made from a suitable material. However, if this is the case it will be a discrete covering and not co-continuous with the water soluble or water dispersible packaging material for the bleaching composition. However, according to the present invention it is most preferred that the at least one solid detergent composition does not have a water soluble or water dispersible coating or cover.

### Water Soluble or Water Dispersible Package

The water soluble or water dispersible package may be of any suitable form.

In some embodiments of the invention it may comprise a partially pre-formed container. Preferred examples of such containers include gelatin capsules, such as those employed in medicament applications. When gelatin is used it will be appreciated that the formulation and the physical nature of the gelatin may wary widely. For example the gelatin may be a hard gelatin or a soft gelatin (having a plasticiser component such as water, glycerine, mono-propylene glycol or polyethylene glycol).

The water soluble or water dispersible package may be in the form of a self supporting body. That is to say the package is not in the form of a walled container but instead a shape, which is substantially self supporting (optionally with pores/apertures). The self supporting body preferably comprises a matrix. The matrix may be formed of the material used for the film of the package or alternatively the matrix may comprise a second material. Preferred matrix forming materials include gelatin, especially in an admixture with glycerine, optionally with water. A further preferred matrix forming material is polyethylene glycol (PEG) having a molecular mass of 3000 or above, e.g. such as 6000, 8000, 20000, 35000 or 8 million.

Generally the package has a maximum dimension in at least one plane of between 5 and 50 mm. It will be appreciated that the size may vary in accordance with desires of the unit dose detergent product formulator the intended use of the package. Typically the package has a maximum dimension in one plane of around 5-50mm, such as 10 to 35 mm. It is especially preferred that the package has this dimension in at least two planes and most preferably in three planes.

The package may be any suitable shape such as spherical or rectangular or square with the latter two shapes being most preferred for some embodiments of the invention where the package is used in a kit of parts with a water-insoluble receptacle comprising at least one chamber for retaining at least one detergent composition.

The package may be formed by any suitable method, for example the method described in WO 2004/081161 which method is incorporated by reference herein.

In particular the method may comprise the step of enveloping the bleaching composition with at least one sheet of the packaging material, especially a flexible sheet of the packaging material. The bleaching composition may be in any suitable form when it is enveloped such as n a solid, slurry or gel form. If it is in a solid form particulate/granular or tablet forms are preferred.

One way of producing the water soluble or water dispersible package containing the bleaching composition is to form a cavity in a first sheet of the packaging material and add the bleaching composition thereto prior to the packaging material being sealed to produce the water soluble or water dispersible package. The package may be sealed by the addition of a second sheet of the packaging material over the cavity containing the bleaching composition and sealing it to the first sheet of the packaging material. The first and second sheets of the packaging material comprise the same or different water soluble or dispersible packaging material, however the two sheets preferably comprise the same packaging material.

Any suitable conventional method may be used to form the water soluble or water dispersible package, e.g. thermo-forming and/or vacuum forming or injection moulding although the latter is less preferred.

### Water Soluble or Water Dispersible Packaging Material

The unit dose detergent composition of the present invention comprises a water soluble or water dispersible package comprising water soluble or water dispersible packaging material. The packaging material is preferably polymeric.

The water soluble or water dispersible packaging material at least partially envelopes the bleaching composition. However it is especially preferred that the bleaching composition is fully enveloped by the packing material.

Preferably the water soluble or water dispersible polymeric material is selected from polyvinyl alcohol, celluloses (including cellulose derivatives), starches, gelatine, polyglycolides, gelatine and polylactides copolymers or a mixture or co-polymer thereof. Preferred cellulose derivatives include hydroxyproppyl cellulose ether (HMPC). The polymeric material may be a photopolymer or a co-polymer of any suitable monomers such as those of the aforementioned types.

The water soluble or water dispersible polymeric material may, for example, be formed of a film. The film may be a single film, or a laminated film as disclosed in GB-A-2,244,258. While a single film may have pinholes, the two or more layers in a laminate are unlikely to have pinholes which coincide. The thickness of the film may be up to 2 mm, more preferably up to 1 mm, more preferably 10 to 300 μm, more preferably 20 to 200 μm, especially 25 to 160 μm, more especially 30 to 150 μm and most especially 30 to 150 μm.

The film may be produced by any process, for example by extrusion and blowing or by casting. The film may be unoriented, monoaxially oriented or biaxially oriented. If the layers in the film are oriented, they usually have the same orientation, although their planes of orientation may be different if desired. The layers in a laminate may be the same or different. Thus they may each comprise the same polymer or a different polymer.

Examples of the water-soluble or dispersible polymeric material which may be used in a single layer film or in one or more layers of a laminate or which may be used for injection moulding or blow moulding are poly(vinyl alcohol) (PVOH), cellulose derivatives such as hydroxypropyl methyl cellulose (HPMC) and gelatin. An example of a preferred PVOH is ethoxylated PVOH. The PVOH may be partially or fully alcoholised or hydrolysed. For example it may be from 40 to 100%, preferably from 70 to 92%, more preferably about 88% or about 92%, alcoholised or hydrolysed. The degree of hydrolysis is known to influence the temperature at which the PVOH starts to dissolve in water. 88% hydrolysis corresponds to a film soluble in cold (i.e. room temperature) water, whereas 92% hydrolysis corresponds to a film soluble in warm water. Therefore the water soluble characteristics of the film can be controlled.

The water soluble or water dispersible package may be formed by, for example, vacuum forming or thermoforming. For example, in a thermoforming process the film may be drawn down or blown down into a mould. Thus, for example, the film is heated to the thermoforming temperature using a thermoforming heater plate assembly, and then drawn down under vacuum or blown down under pressure into the mould. Plug-assisted thermoforming and pre-stretching the film, for example by blowing the film away from the mould before thermoforming, may, if desired, be used. One skilled in the art can choose an appropriate temperature, pressure or vacuum and dwell time to achieve an appropriate package. The amount of vacuum or pressure and the thermoforming temperature used depend on the thickness and porosity of the film and on the polymer or mixture of polymers being used. Thermoforming of PVOH films is known and described in, for example, WO 00/55045.

A suitable forming temperature for PVOH or ethoxylated PVOH is, for example, from 90 to 130° C., especially 90 to 120° C. A suitable forming pressure is, for example, 69 to 138 kPa (10 to 20 p.s.i.), especially 83 to 117 kPa (12 to 17 p.s.i.). A suitable forming vacuum is 0 to 4 kPa (0 to 40 mbar), especially 0 to 2 kPa (0 to 20 mbar). A suitable dwell time is, for example, 0.4 to 2.5 seconds, especially 2 to 2.5 seconds.

In case of encapsulation of the bleaching composition in hard gelatin capsules to form the package it may be completely filled or only partially filled with the bleaching composition. In case of encapsulation in soft gelatin capsules the bleaching composition contained therein may be in a liquid form, which may be thickened or gelled if desired and which may be non-aqueous or aqueous, for example comprising less than or more than 5% total or free water. Hard gelatine capsules are usually soluble in water at above ambient temperature whilst soft gelatin capsules are generally soluble in water at ambient temperature.

While desirably conditions chosen within the above ranges, it is possible to use one or more of these parameters outside the above ranges, although it may be necessary to compensate by changing the values of the other two parameters.

### Bleaching Composition

The water soluble or water dispersible package at least partially envelopes a bleaching composition comprising a bleaching compound.

The bleaching composition may consist essentially of a bleaching compound. However the bleaching composition preferably comprises 25% wt to 99% wt of the bleaching compound based on the total weight of the bleaching composition, more preferably 50% wt to 95% wt, such as 70% to 90% wt. The remainder of the bleaching composition may comprise any suitable compatible materials such as stabilisers for the bleach and fillers. Suitable stabilising materials include materials which are capable of taking up water, e.g. as water of crystallisation, such as sulphates.

The bleaching composition may be in any suitable form. However it is preferred according to the present invention that the bleaching composition is in a solid, slurry or gel form, especially a solid form with particulate (including granular and powder forms) and tablets being most preferred.

Any type of bleaching compound conventionally used in detergent compositions may be used according to the present invention in the bleaching composition.

The bleaching compound preferably comprises at least one inorganic peroxide or organic peracid or a chlorine based bleach including derivatives and salts thereof or mixtures thereof.

Preferably the at least one inorganic peroxide comprises a percarbonate, perborate and persulphate and/or hydrogen peroxide including derivatives and salts thereof and mixtures thereof. The sodium and potassium salts of these inorganic peroxides being most preferred, especially the sodium salts. Sodium percarbonate and sodium perborate are most preferred, especially sodium percarbonate.

It is especially preferred according to the present invention that the bleaching compound comprises at least one organic peracid including derivatives and salts and mixtures thereof. Organic peracids suitable according for use in the present invention include all organic peracids traditionally used as bleaches. Preferred examples include perbenzoic acid and peroxycarboxylic acids especially mono- or diperoxyphthalic acid, 2-octyldiperoxysuccinic acid, diperoxydodecanedicarboxylic acid, diperoxy-azelaic acid, phthalimidoperhexanoic acid (PAP) and imidoperoxycarboxylic acid and the derivatives and salts and mixtures thereof. Especially preferred is phthalimidoperhexanoic acid (PAP) and the derivatives and salts and mixtures thereof.

It is preferred that the bleaching composition comprises less than 5% wt of bleach sensitive ingredients and more particularly that it is substantially free from bleach sensitive ingredients. Most preferably the bleaching composition is free from bleach sensitive ingredients. Preferably the at least one additional solid detergent comprises less than 5% wt of bleaching compound and more preferably it is substantially free from bleaching compound, most preferably free from bleaching compound.

The unit dose detergent composition typically comprises from 0.5 to 50% wt of the water soluble or water dispersible package containing the bleaching composition based on the total weight of the unit dose detergent composition. More preferably the unit dose detergent composition comprises from 1 to 30% wt, especially 2 to 20% wt, such as 3 to 10% wt of the package containing the bleaching composition.

### Additional Solid Detergent Composition(s)

The unit dose detergent compositions of the invention comprise at least one solid detergent composition in addition to the water soluble or water dispersible package comprising a bleaching composition.

Typically, and preferably, the at least one additional solid detergent composition will be in the form of a shaped body such as a tablet, rod, ball or lozenge. Alternatively the at least one additional solid detergent composition may be in the form of a powder or granular material. The shaped body may be formed of compressed powder or cast, injection moulded or extruded material. Any suitable conventional method may be used to produce the solid detergent composition e.g. tabletting of granular/particulate material or injection moulding and these processes are well know to the person skilled in the art and thus do not need to be described further here. Where the compositions of the present invention comprise two or more solid detergent compositions these may be formed by the same or different methods.

According to an especially preferred embodiment of the present invention the unit dose detergent product comprises at least two of the additional detergent compositions in solid form. In this case the two or more additional solid compositions may be of the same of different formulations as desired. According to one embodiment of the invention it is preferred that the formulations of the additional solid detergent compositions are the same.

When the unit dose detergent compositions comprises at least two of the additional solid detergent compositions, it is most preferred that in use the water soluble or water dispersible package is positioned such that it is located substantially between at least two of the additional solid detergent compositions. In other words, it has at least one of the additional solid detergent compositions on either side of it, preferably arranged such that the solid detergent compositions are approximately opposite to each other with the package of the invention located there-between. This has the advantage of providing protection for the package against the detrimental effects external influences such as moisture and/or above ambient temperatures which are detrimental to stability (e.g. the package may loose integrity, dissolve or weaken) and is especially useful when the unit dose detergent composition is used in a kit-of-parts and/or in a multi-dosing detergent device as herein described.

It is also possible to provide the bleaching composition in the form of a compressed tablet which need not be enveloped by water soluble or water dispersible material. In this case the compressed tablet of the bleaching composition is preferably placed between two of the additional solid detergent compositions in use e.g. in a water insoluble receptacle and/or in a multi-dosing detergent device.

### -Bleach Sensitive Material

The at least one additional solid detergent composition (s) comprises a bleach sensitive material. The bleach sensitive material may be present in any suitable amount and this will vary according to the nature of the material.

Bleach sensitive ingredients include enzymes which may be present in conventional amounts. Any type of enzyme typically used in detergent compositions may be used according to the present invention. It is preferred that the enzyme is selected from proteases, lipases, amylases, cellulases and peroxidases, with proteases and amylases, especially proteases being most preferred. It is most preferred that protease and/or amylase enzymes are included in the compositions according to the invention as such enzymes are especially effective for example in dishwashing detergent compositions. Any suitable species of these enzymes may be used as desired.

The bleach sensitive ingredient may also comprise a perfume or dye. Any type of perfume or dye may be used in conventional amounts.

The bleach sensitive material may preferably comprise one or more bleach activators or bleach catalysts depending upon the nature of the bleaching compound. Any suitable bleach activator may be included for example TAED. Any suitable bleach catalyst may be used for example manganese acetate or dinuclear manganese complexes such as those described in EP-A-1,741,774. Conventional amounts may be used e.g. in amounts of from 0.01 to 10 wt %, more preferred of from 0.1 to 8 wt % and most preferred of from 0.5 to 5 wt % based on the weight of the total composition.

### -Surfactant

In addition to the bleach sensitive material the additional solid detergent composition(s) further comprises a surfactant and/or builder.

If a surfactant is present it may be any of nonionic, anionic, cationic, amphoteric or zwitterionic surface active agents or mixtures thereof. Many such suitable surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred according to the present invention.

Non-ionic surfactants are especially preferred according to the present invention, especially for automatic dishwashing compositions. For laundry and cleaning applications (excluding automatic dishwashing) other surfactants such as anionic surfactants are preferably included and suitable types are well known in the art.

A preferred class of nonionic surfactants are ethoxylated non-ionic surfactants prepared by the reaction of a mono-hydroxy alkanol or alkylphenol with 6 to 20 carbon atoms. Preferably the surfactants have at least 12 moles particularly preferred at least 16 moles, and still more preferred at least 20 moles, such as at least 25 moles of ethylene oxide per mole of alcohol or alkylphenol.

Particularly preferred non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols, which additionally comprises polyoxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant. Another class of suitable non-ionic surfactants includes reverse block copolymers of polyoxyethylene and polyoxypropylene and block copolymers of polyoxyethylene and polyoxypropylene initiated with trimethylolpropane. Another preferred class of nonionic surfactant can be described by the formula:

R¹O[CH2CH(CH₃)O]_{X}[CH₂CH₂O]_{Y}[CH₂CH(OH)R²]

where R¹ represents a linear or branched chain aliphatic hydrocarbon group with 4-18 carbon atoms or mixtures thereof, R represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]_{X}[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³ H, methyl or ethyl is particularly preferred. Particularly preferred values for x are comprised between 1 and 20, preferably between 6 and 15.

As described above, in case x>2, each R³ in the formula can be different. For instance, when x=3, the group R could be chosen to build ethylene oxide (R³═H) or propylene oxide (R³=methyl) units which can be used in every single order for instance (PO) (EO) (EO), (EO) (PO) (EO), (EO) (EO) (PO), (EO) (EO) (EO), (PO) (EO) (PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH (R³)O]_{X}CH₂CH(OH)CH₂OR²

The use of mixtures of different nonionic surfactants is suitable in the context of the present invention for instance mixtures of alkoxylated alcohols and hydroxy group containing alkoxylated alcohols.

Other suitable surfactants are disclosed in WO 95/01416, to the contents of which express reference is hereby made.

Preferably the non-ionic surfactants are present in the solid detergent compositions of the invention in an amount of from 0.1 % wt to 20 % wt, more preferably 1% wt to 15 % wt, such as 2 to 10% wt. Where there are two or more of the additional solid detergent compositions the amounts of surfactant in each composition may be the same or different but preferably varies by no more than 50% between the compositions expressed as a percentage of the amount of surfactant.

### - Builder

If a builder is present it may comprise either a phosphorous-containing builder or a phosphorous-free builder as desired.

If phosphorous-containing builders are also to be used in the detergent compositions of the inventions then it is preferred that mono-phosphates, di-phosphates, tri-polyphosphates or oligomeric-poylphosphates are used. The alkali metal salts of these compounds are preferred, in particular the sodium salts. An especially preferred builder is sodium tripolyphosphate (STPP). Conventional amounts of the phosphorous-containing builders may be used in the solid detergent compositions, typically in the range of from 15% wt to 60% wt, such as 20 or 25% wt to 40 or 50% wt.

If a phosphorous-free builder is included in the compositions of the invention it is preferably chosen from amino acid based compounds and/or succinate based compounds. The terms ‘succinate based compound’ and ‘succinic acid based compound’ are used interchangeably herein. Conventional amounts of the amino acid based compound and/or succinate based compound may be used in the solid detergent compositions, typically in the range of from 20% wt to 80% wt, such as 25 or 30% wt to 60 or 70% wt.

Preferred examples of amino acid based compounds which may be used according to the invention are MGDA (methyl-glycine-diacetic acid, and salts and derivatives thereof) and GLDA (glutamic-N,N-diacetic acid and salts and derivatives thereof). Other suitable builders are described in U.S. Pat. No. 6,426,229 which are incorporated by reference herein. Particular suitable builders include; for example, aspartic acid-N-monoacetic acid (ASMA), aspartic acid-N,N-diacetic acid (ASDA), aspartic acid-N- mono-propionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N- methyliminodiacetic acid (MIDA) , α-alanine-N, N-diacetic acid (α-ALDA) , β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N, N-diacetic acid (TUDA) and sulfomethyl-N,N-diacetic acid (SMDA) and alkali metal salts or ammonium salts thereof.

Further preferred succinate compounds are described in U.S. Pat. No. 5,977,053 and have the formula;

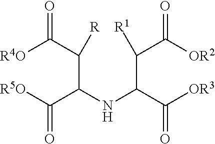

in which R, R¹, independently of one another, denote H or OH, R², R³, R⁴, R⁵, independently of one another, denote a cation, hydrogen, alkali metal ions and ammonium ions, ammonium ions having the general formula R⁶ R⁷ R⁸ R⁹ N+ and R⁶, R⁷, R⁸, R⁹, independently of one another, denoting hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts.

It is especially preferred according to the present invention that the builder comprises methyl-glycine-diacetic acid, glutamic-N,N-diacetic acid, tetrasodium imminosuccinate, or (hydroxy)iminodisuccinic acid and salts or derivatives thereof.

The phosphorous-free builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

Preferably the total amount of builder present in the solid compositions is an amount of at least 20 wt %, and most preferably at least 25 wt %, preferably in an amount of up to 70 wt %, preferably up to 65 wt %, more preferably up to 60 wt %. The actual amount used in the compositions will depend upon the nature of the builder used. If desired a combination of phosphorous-containing and phosphorous-free builders may be used.

### -Optional Ingredients

A preferred optional ingredient in the solid detergent composition is a dissolution retarder. The compositions may comprise a dissolution retarder so that the speed of dissolution of the composition is slowed compared to the same composition which does not contain the dissolution retarding agent. This allows for the composition to dissolve predominantly in the main wash of an automatic washing process rather than in the pre-wash. Suitable dissolution retarders are described in WO 2009/024780 and are incorporated by reference herein.

Preferred dissolution retarders, as described in WO 2009/024780 are copolymers (or the alkali metal, alkaline earth metal, ammonium or transition metal salt thereof) formed from the copolymerisation of acrylamidoalkylsulphonic acids with;

a) at least one cyclic N-vinylcarboxamide, vinyl acetate, ethyleneimine, vinyl imidazole, acrylic acid or maleic acid, or
b) (i) at least one cyclic N-vinylcarboxamide, vinyl acetate, ethyleneimine, vinyl imidazole, acrylic acid or maleic acid and (ii) at least one linear N-vinylcarboxamide.

These copolymers may be formed optionally with one or more further monomers, including, monomers which act as cross-linking agents.

The detergent compositions of the invention may optionally further comprise a secondary builder (or cobuilder). Preferred secondary builders include homopolymers and co-polymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred. A polymeric polycarboxylic acid is the homopolymer of acrylic acid. Other suitable secondary builders are disclosed in WO 95/01416, to the contents of which express reference is hereby made.

Preferably the total amount of co-builder present in the compositions is an amount of up to 10 wt %, preferably at least 5 wt %. The actual amount used in the compositions will depend upon the nature of the builder used.

The compositions according to the invention may also comprise a source of acidity or a source of alkalinity, to obtain the desired pH, on dissolution, especially if the composition is to be used in an automatic dishwashing application. Preferred silicates are sodium silicates such as sodium disilicate, sodium metasilicate and crystalline phyllosilicates. A source of acidity may suitably be any suitable acidic compound for example a polycarboxylic acid. For example a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity. Conventional amounts of the alkalinity or acidity source may be used.

The solid detergent compositions may comprise one or more anti-corrosion agents, especially when the detergent compositions are for use in automatic dishwashing operations. These anti-corrosion agents may provide benefits against corrosion of glass and/or metal and the term encompasses agents that are intended to prevent or reduce the tarnishing of non-ferrous metals, in particular of silver and copper. In many detergent compositions according to the present invention it may be desirable to include more than one type of anti-corrosion agent to provide protection against corrosion of glass and metals.

It is known to include a source of multivalent ions in detergent compositions, and in particular in automatic dishwashing compositions, for anti-corrosion benefits.

For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, bismuth, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylace-tonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂ and Ce(NO₃)₃. Any suitable source of multivalent ions may be used, with the source preferably being chosen from sulphates, carbonates, acetates, gluconates and metal-protein compounds. Zinc salts are specially preferred corrosion inhibitors.

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

Therefore, an especially preferred optional ingredient according to the present invention is a source of multi-valent ions such as those mentioned in the immediately preceding paragraphs and in particular compounds comprising zinc, bismuth and/or manganese ions and/or benzotriazole, including substituted benzotriazoles. In particular a source of zinc ions and unsubstituted benzotriazole are preferred as anti-corrosion agents and a mixture of these two ingredients is especially preferred according to the invention.

Any conventional amount of the anti-corrosion agents may be included in the solid detergent compositions of the invention. However, it is preferred that they are present in an total amount of from 0.01% wt to 5% wt, preferably 0.05% wt to 3% wt, more preferably 0.1 to 2.5% wt, such as 0.2% wt to 2% wt based on the total weight of the composition. If more than one anti-corrosion agent is used, the individual amounts may be within the preceding amounts given but the preferred total amounts still apply.

Polymers intended to improve the cleaning performance of the detergent compositions may also be included therein. For example sulphonated polymers may be used. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-l-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3- (2-propenyloxy) propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541.

When a sulfonated polymer is present, it is preferably present in the solid detergent composition in an amount of at least 0.1 wt %, preferably at least 0.5 wt %, more preferably at least 1 wt %, and most preferably at least 3wt %, up to 40 wt %, preferably up to 25 wt %, more preferably up to 15 wt %, and most preferably up to 10 wt %.

The solid detergent composition may also comprise one or more foam control agents. Suitable foam control agents for this purpose are all those conventionally used in this field, such as, for example, silicones and their derivatives and paraffin oil. The foam control agents are preferably present in the composition in amounts of 0.5% by weight or less of the total weight of the composition. The amount in each distinct region may be chosen as desired.

If the solid detergent composition is in the form of a shaped body then a conventional amount of a binder material may be included in that region. Any conventional binders may be used, typically in an amount of up to 10% wt, more preferably in an amount of up to 5% wt in that distinct region. Suitable binders include polyethylene glycols and/or glycerol.

The solid detergent compositions of the invention may also comprise minor, conventional, amounts of preservatives. Such ingredients are typically present in amounts of up to 2% wt.

### Kit-of-Parts

The present invention also provides a kit-of-parts comprising 1) a water-insoluble receptacle comprising at least one chamber for retaining at least one detergent composition and 2) a unit dose detergent composition according to the first aspect of the invention.

It is especially preferred that the water insoluble receptacle comprises a plurality of chambers. This arrangement allows the receptacle to be used in a multi-dosing detergent device to take the benefit of the advantages of the invention.

It is preferred that the kit-of-parts contains at least one chamber of the water-insoluble receptacle contains a unit dose detergent composition of the invention. Preferably each chamber of the receptacle contains a unit dose composition according to the invention. It is however possible to include other compositions, e.g. machine cleaning compositions, in one or more chambers of the receptacle if desired. According to one embodiment of the invention, and especially when the kit of parts is to be used in assembled form in an multi-dosing detergent device, from 2 to 30 of the unit dose detergent compositions of the invention are individually retained in the receptacle by the same number of chambers, e.g. 12 unit dose detergent portions are individually retained by 12 chambers in the water insoluble-receptacle.

This kit may come ready assembled with the unit dose detergent composition of the first aspect contained with the water-insoluble receptacle or alternatively it may be provided together as a kit to be assembled by the use prior to use.

It is also possible that the two parts of the kit may be provided separately with instructions to use them together in a cleaning operation.

The water insoluble receptacle may be of any suitable form. Suitable examples are described in WO 2008/053178(incorporated by reference herein) where they are used inside a multi-dosing detergent device.

The unit dose detergent composition of the invention or the kit-of-parts of the invention (especially in assembled form with the unit dose detergent composition retained within the water-insoluble receptacle) are intended to be used in a washing operation, especially in an automatic dishwashing operation.

It is especially preferred that the unit dose detergent composition and the kit of parts according to the invention are used in a multi-dosing detergent device, e.g. such a device to be used in an automatic dishwashing operation.

### Multi-Dosing Detergent Device

A multi-dosing detergent device comprising the unit dose detergent composition, or, the kit-of-parts according to the present invention is also provided. Suitable devices are described for example in WO 2008/053178 (incorporated by reference herein).

The invention is further described with reference to the following non-limiting Examples. Further examples within the scope of the invention will be apparent to the person skilled in the art.

### EXAMPLES

### Example 1a, 1b and 1c

Three unit dose detergent compositions were prepared according to the present invention. The compositions comprised 1) 1.5 g of PAP in powder form enveloped in a PVOH water soluble envelope and 2) the solid detergent composition (in elongated tablet form) as below. The solid detergent compositions were prepared by mixing together the ingredients to form a granular mixture and compacting the same. In use the PAP envelope is placed between two solid detergent tablets of the stated compositions.

| | Ex 1a | Ex 1b | Ex 1c |
|---|---|---|---|
| Raw materials | % wt | % wt | % wt |
| PEG 2000 | — | — | 2.00 |
| PEG 6000 | — | 6.00 | — |
| Trisodium citrate | 30.00 | — | — |
| MGDA granulate | 43.50 | 60.80 | 33.50 |
| HEDP | 0.50 | 0.50 | 0.50 |
| Sodium tripoly- | — | — | 23.85 |
| phosphate | | | |
| (granular) | | | |
| Sodium silicate | 7.00 | 5.00 | 3.00 |
| Soda | 3.10 | 11.80 | 16.60 |
| Granular non | 1.50 | 1.50 | 4.00 |
| ionic surfactant | | | |
| C16-18 + EO 20-30 | | | |
| Liquid non ionic | 3.00 | 3.00 | 2.50 |
| surfactant | | | |
| C13-15 + EO 4-6 + | | | |
| BuO 1-3 | | | |
| Acrylic acid / | 8.00 | 8.00 | 8.00 |
| Maleic acid co- | | | |
| polymer - granu- | | | |
| lar - Average MW | | | |
| 70 kg/mol. | | | |
| Protease | 2.25 | 2.25 | 2.25 |
| Amylase | 0.50 | 0.50 | 0.60 |
| Glycerol | 0.50 | 0.50 | 0.75 |
| Perfume | 0.15 | 0.15 | 0.15 |
| Antifoam | | | 0.30 |
| Total of raw ma- | 100.00% | 100.00% | 100.00% |
| terials | | | |

### Example 2a

A unit dose detergent composition was prepared according to the invention but with two solid detergent compositions of different formulation in combination with the 1.5 g of PAP in powder form enveloped in a PVOH water soluble envelope.

| | First solid | Second solid |
|---|---|---|
| | detergent | detergent |
| raw materials | % wt | % wt |
| PEG 2000 | 5.00 | 5.00 |
| MGDA granulate | 64.10 | |
| HEDP | 0.50 | 0.50 |
| Sodium tripolyphos- | — | 45.75 |
| phate (granular) | | |
| Sodium silicate | 3.00 | 3.00 |
| Soda | 10.70 | 23.55 |
| Granular non ionic | 2.50 | 2.50 |
| surfactant C16-18 + | | |
| EO 20-30 | | |
| Liquid non ionic | 3.00 | 3.00 |
| surfactant | | |
| C13-15 + EO 4-6 + | | |
| BuO 1-3 | | |
| Acrylic acid/ | 10.00 | 10.00 |
| Maleic acid copoly- | | |
| mer - granular - | | |
| Average MW | | |
| 70 kg/mol. | | |
| | 5.00 | 5.00 |
| Protease | — | 4.50 |
| Amylase | — | 1.00 |
| Glycerol 90% | 0.75 | 0.75 |
| Perfume | 0.15 | 0.15 |
| Antifoam | 0.30 | 0.30 |
| Total of raw mate- | 100.00% | 100.00% |
| rials | | |

### Example 3

A unit dose detergent composition was prepared according to the invention with 2.5 g sodium percarbonate granulated encapsulated in a water soluble package according to Claim 1. This is used in combination with the solid detergent composition of any one of examples 1a, 1b or 1c.

The unit dose detergent products of any all of examples 1, 2 and 4 show good stability to above ambient temperatures and high levels of humidity. In particular these compositions can be used in multi-dosing detergent devices and be present in an automatic dishwashing machine over a plurality of dishwashing cycles and still perform well and demonstrate good physical and chemical stability.

1. A unit dose detergent composition comprising;
1) a water soluble or water dispersible package comprising water soluble or water dispersible packaging material and a bleaching composition comprising a bleaching compound, the bleaching composition being at least partly enveloped by the packaging material; and
2) at least one additional solid detergent composition comprising a bleach sensitive material and a surfactant or builder and which is not enveloped by the packaging material.

2. A unit dose detergent composition according to claim 1, wherein the composition is an automatic dishwashing detergent composition,

3. A unit close detergent composition according to claim 1, wherein the packaging material comprises a water soluble or water dispersible polymeric material selected from polyvinyl alcohol, celluloses, starches, gelatine, polyglycolides, gelatine and polylactides copolymers or a mixture or co-polymer thereof.

4. A unit close detergent composition according to claim 1, wherein the bleaching composition comprises 25% wt to 99% wt of the bleaching compound based on the total weight of the bleaching composition.

5. A unit dose detergent composition according to claim 1, wherein the bleaching composition is in a solid, slurry or gel form.

6. A unit dose detergent composition according to claim 5, wherein the solid is in a particulate or in a tablet form.

7. A unit dose detergent composition according to claim 1, wherein the bleaching compound comprises at least one inorganic peroxide or organic peracid or a chlorine based bleach including derivatives and salts thereof or mixtures thereof,

8. A unit dose detergent composition according to claim 7, wherein the at least one inorganic peroxide comprises a percarbonate, perborate, persulphate or hydrogen peroxide including derivatives and salts thereof and mixtures thereof.

9. A unit dose detergent composition according to claim 7, wherein the at least one organic peracid comprises perbenzoic acid or a peroxycarboxylic acid.

10. A unit dose detergent composition according to claim 9, wherein the at least one peroxycarboxylic acid comprises monoperoxyphthalic acid, diperoxyphthalic acid, 2-octyldiperoxysuccinic acid, diperoxydodecanedicarboxylic acid, diperoxy-azelaic acid, imidoperoxycarboxylic acid or phthalimidoperhexanoic acid including derivatives or salts thereof or mixtures thereof.

11. A unit dose detergent composition according to claim 1, comprising at least two of the additional solid detergent compositions.

12. A unit dose detergent composition according to claim 1, wherein the surfactant comprises non-ionic surfactant.

13. A unit dose detergent composition according to claim 1, wherein the builder comprises a phosphorous-containing builder.

14. A unit dose detergent composition according to claim 1, wherein the builder comprises a phosphorous-free builder.

15. A unit dose detergent composition according to claim 14, wherein the phosphorous-free builder comprises amino acid based compounds or succinate based compounds.

16. A unit dose detergent composition according to claim 15, wherein the phosphorus-free builder composes methyl-glycine-diacetic acid, glutamic-N,N-diacetic acid, tetrasodium imminosuccinate, or (hydroxy)iminodisuccinic acid or salts or derivatives thereof.

17. A unit dose detergent composition according to claim 1, wherein the at least one additional solid detergent composition runner comprises a dissolution retarder.

18. A unit dose detergent composition according to claim 1, wherein the at least one additional solid detergent composition is in the form of a shaped body.

19. A unit dose detergent composition according to claim 1, wherein the water soluble or water dispersible package is positioned substantially between at least two of the additional solid detergent compositions.

20. A kit comprising
1) a water-insoluble receptacle comprising at least one chamber for retaining at least one detergent compositions and.
2) a unit dose detergent composition according to claim 1.

21. A kit according to claim 20, wherein the water-insoluble receptacle comprises a plurality of chambers.

22. A kit according to claim 20, wherein at least one chamber contains a unit dose detergent composition which comprises:
1) a water soluble or water dispersible package comprising water soluble or water dispersible packaging material and a bleaching composition comprising a bleaching compound, the bleaching composition being at least partly enveloped by the packaging material; and
at least one additional solid detergent composition comprising a bleach sensitive material and a surfactant or builder and which is not enveloped by the packaging material.

23. A kit according to claim 22, wherein each chamber contains a unit dose detergent composition which comprises:
1) a water soluble or water dispersible package comprising water soluble or water dispersible packaging material and a bleaching composition comprising a bleaching compound, the bleaching composition being at least partly enveloped by the packaging material; and
2) at least one additional solid detergent composition comprising a bleach sensitive material and a surfactant or builder and which is not enveloped by the packaging material.

24. A kit according to claim 21, wherein from 2 to 30 of the unit dose detergent compositions are individually retained by the same number of chambers in the receptacle.

25. A kit according to claim 20, wherein the water soluble or water dispersible package is located substantially between at least two additional solid detergent compositions.

26. A method of washing dishware in an automatic dishwashing operation, the method comprising the steps of:
providing a unit dose detergent composition which comprises:
1) a water soluble or water dispersible package comprising water soluble or water dispersible packaging material and a bleaching composition comprising a bleaching compound, the bleaching composition being at least partly enveloped by the packaging material; and
2) at least one additional solid detergent composition comprising a bleach sensitive material and a surfactant or builder and which is not enveloped by the packaging material to an automatic dishwashing apparatus, and
dispersing the detergent composition within the interior of the automatic dishwashing apparatus during the automatic dishwashing operation.

27. (canceled)

28. The method according to claim 26, wherein the unit dose detergent composition is a multi-dosing detergent device.

29. A multi-dosing detergent device comprising a unit dose detergent composition which comprises:
1) a water soluble or water dispersible package comprising water soluble or water dispersible packaging material and a bleaching composition comprising a bleaching compound, the bleaching composition being at least partly enveloped by the packaging material; and
2) at least one additional solid detergent composition comprising a bleach sensitive material and a surfactant or builder and which is not enveloped by the packaging material to an automatic dishwashing apparatus, and.

30. A method of washing dishware in an automatic dishwashing operation, the method comprising the steps of:
providing a kit which includes:
A) a water-insoluble receptacle comprising at least one chamber for retaining at least one detergent composition; and,
B) a unit dose detergent which comprises:
1) a water soluble or water dispersible package comprising water soluble or water dispersible packaging material and a bleaching composition comprising a bleaching compound, the bleaching composition being at least partly enveloped by the packaging material; and
2) at least one additional solid detergent composition comprising a bleach sensitive material and a surfactant or builder and which is not enveloped by the packaging material to an automatic dishwashing apparatus, and dispensing the detergent composition within the interior of the automatic dishwashing apparatus during the automatic dishwashing operation.

31. A multi-dosing detergent device comprising a unit dose detergent composition which comprises:
a kit which includes:
A) a water-insoluble receptacle comprising at least one chamber for retaining at least one detergent composition; and,
B) a unit dose detergent which comprises:
1) a water soluble or water dispersible package comprising water soluble or water dispersible packaging material and a bleaching composition comprising a bleaching compound, the bleaching composition being at least partly enveloped by the packaging material; and
2) at least one additional solid detergent composition comprising a bleach sensitive material and a surfactant or builder and which is not enveloped by the packaging material to an automatic dishwashing apparatus.
